(19) United States
(12) Patent Application Publication
(10) Pub. No.: US 2005/0047373 A1
(43) Pub. Date: Mar. 3, 2005

(54) Mobile communication terminal and wireless communication system

(75) Inventor: Masaya Kojima, Kawasaki-shi (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 10/924,421

(22) Filed: Aug. 24, 2004

(30) Foreign Application Priority Data
Aug. 29, 2003 (JP) 2003-307220

(51) Int. Cl. H04B 7/216; H04Q 7/20

(52) U.S. Cl. 370/331; 370/335

(57) ABSTRACT

A mobile wireless communication terminal includes: a first communication unit for communicating over a wireless communication with a first communication system which covers a local area; a second communication unit for communicating over a wireless communication with a second communication system which covers a wide area; an area detection unit for detecting a wireless service area of the first communication system; and a control unit for switching from a second wireless communication path established by the second communication unit to a first wireless communication path established by the first communication unit in response to the area detection unit detecting a wireless service area while communicating over the wireless communication using the second communication unit.

Priority is claimed on Japanese Patent Application No. 2003-307220, filed Aug. 29, 2003, the content of which is incorporated herein by reference.

### BACKGROUND OF THE INVENTION

1. Field of the Invention

The present invention relates to a wireless mobile communication system. More specifically, the present invention relates to a wireless mobile communication terminal which can participate in wireless communication with a communication system which covers a local area, e.g., a wireless local area network (LAN), such as a mobile telephone, and a wireless communication system including such a mobile communication terminal and a server.

2. Description of Related Art

Recently, high-speed data communication via a wireless LAN using a mobile communication terminal, such as mobile telephones and personal computers, has been offered. For example, a user of a mobile telephone can access to a wireless LAN when the user carrying the mobile telephone is within a “hotspot” which is a wireless service area of a wireless communication. The exact positions of such hotspots vary on a day-to-day basis due to installation of new base stations or removal of ones, and fluctuations in the propagation characteristics of radio waves due to change in the environment surrounding the base station, such as construction of buildings or other structures.

Therefore, a user must check whether the location where the user wants to access the wireless LAN is within a hotspot currently in service before actually making a connection.

Therefore, the user must register prospective hotspots which had provided and/or provide a wireless LAN connection (at present, cafes, fast-food restaurants, hotels and the like offer hotspots to their customers) in the user's mobile telephone beforehand. The user checks whether or not the registered places are currently functioning as a hotspot, and if so, the user can go to the place and switch from a communication mode using a mobile phone network, e.g., a CDMA2000 1xEV-DO network, provided by a mobile phone carrier to another communication mode using the wireless LAN, thereby enjoying a high-speed data communication on the mobile telephone, e.g., exchanging emails or browsing websites on the Internet. The user checks whether or not the registered prospective places function as a hotspot by obtaining information on the hotspots currently in service from various sources, for example books, television, and the Internet.

Currently, the wireless LAN technology is employed in various applications. One example of such an application is a traffic information system. In such a system, the current road traffic status is estimated, and information is provided to subscribers of a communication service. For making estimations of the traffic on the roads located within the wireless communication network, information on the wireless network of the past and the present are analyzed. Examples of data to be collected and analyzed are as follows:
1. How many end-user wireless devices are communicating, and how many are not communicating within a cell at a predetermined point in time?
2. How many end-user wireless devices which are communicating and end-user wireless devices which are not communicating are registered to a location area of the wireless communication network?
3. During a predetermined time period, how long has an on-vehicle end-user device stayed within one or more cells, and how long is it expected to stay there?

As another example, Japanese Laid-Open Patent Application No. 2002-300644 discloses the CDMA2000 1xEV-DO technology which is one of next-generation wireless communication systems.

One of the disadvantages of the conventional wireless communication system is time-sensitiveness of hotspot information: the older, the less variable. However, it is difficult at present for subscribers to obtain hotspot information which was updated one hour ago from sources such as books and television. Another disadvantage is that a user needs to follow a cumbersome procedure to switch from a communication mode using CDMA2000 1xEV-DO to a communication mode using a wireless LAN. For example, a subscriber is requested to enter a password. Sometimes, this discourages users from frequently accessing a wireless LAN.

Furthermore, the above-mentioned traffic information system employing the wireless LAN technology is aimed at obtaining traffic information. The wireless communication is used only as a means for determining the traffic status, rather than a means for increasing the convenience of the mobile communication terminal. Furthermore, the system offers no advantage to mobile subscribers who are carrying around such communication terminals.

### SUMMARY OF THE INVENTION

The present invention is directed to solve the above-mentioned disadvantages of the conventional wireless communication system by providing a mobile communication terminal, e.g., a mobile telephone, which can switch between a communication mode using a wireless LAN and a communication mode using a different communication system, e.g., the CDMA2000 1xEV-DO network, and which automatically switches between communication modes based on the latest hotspot information.

Furthermore, the present invention is directed to a server-based management of the latest hotspot information.

To attain the above-mentioned object, a mobile communication terminal according to a first aspect of the present invention includes: a first communication unit for communicating over a wireless communication with a first communication system which covers a local area; a second communication unit for communicating over a wireless communication with a second communication system which covers a wide area; an area detection unit for detecting a wireless service area of the first communication system; and a control unit for switching from a second wireless communication path established by the second communication unit to a first wireless communication path established by the first communication unit in response to the area detection unit detecting a wireless service area while communicating over the wireless communication using the second communication unit.

In the mobile communication terminal according to the first aspect of the present invention, the control unit may switch from the first communication path established by the first communication unit to the second communication path established by the second communication unit in response to the area detection unit losing a signal from the wireless service area.

The second communication system may be a system employing the CDMA2000 1xEV-DO technology.

A mobile communication terminal according to a second aspect of the present invention may include: a first communication unit for communicating over a wireless communication with a first communication system which covers a local area; a second communication unit for communicating over a wireless communication with a second communication system which covers a wide area; an area detection unit for detecting a wireless service area of the first communication system; a position determining unit for determining a position of the mobile communication terminal; and a control unit for sending positional data of the mobile communication terminal determined by the position determining unit to a server via one of the first and the second communication units in response to the area detection unit detecting the wireless service area.

The mobile communication terminal according to a third aspect of the present invention includes: a first communication unit for communicating over a wireless communication with a first communication system which covers a local area; a second communication unit for communicating over a wireless communication with a second communication system which covers a wide area; an area detection unit for detecting a wireless service area of the first communication system; a position determining unit for determining a position of the mobile communication terminal; and a control unit for sending positional data of the mobile communication terminal determined by the position determining unit to a server via the second communication unit in response to the area detection unit losing a signal from the wireless service area.

The mobile communication terminal according to the third aspect of present invention may further include: a service area information receiving unit for receiving information on at least one of wireless service areas of the first communication system from a server via one of the first and the second communication units; and a notification unit for indicating the at least one of the wireless service areas of the first communication system based on the received information on the at least one of the wireless service areas.

In the mobile communication terminal according to the third aspect of the present invention, the control unit may send the positional data to a server while communicating over the wireless communication using the second communication unit.

In the mobile communication terminal according to the third aspect of the present invention, the second communication system may be a system employing the CDMA2000 1xEV-DO technology.

A wireless communication system according to a fourth aspect of the present invention includes a mobile communication terminal for communicating over a first communication system which covers a local area and over a second communication system which covers a wide area, and a server for managing data received from the mobile communication terminal. In the wireless communication system, the mobile communication terminal includes: an area detection unit for detecting a wireless service area of the first communication system; a position determining unit for determining a position of the mobile communication terminal; a control unit for sending positional data of the mobile communication terminal determined by the position determining unit to the server in response to one of the following events: the area detection unit detecting the wireless service area, and the area detection unit losing a signal from the wireless service area; a service area information receiving unit for receiving information on at least one of wireless service areas of the first communication system from the server; and a notification unit for indicating the at least one of the wireless service areas of the first communication system based on the received information on the at least one of the wireless service areas.

The server includes: a receiving unit for receiving from the mobile communication terminal positional data related to a wireless service area of the first communication system; a managing unit for managing the received positional data as the information on the at least one of the wireless service areas; and a transmission unit for sending the information on the at least one of the wireless service areas information managed by the managing unit to the mobile communication terminal.

According to the above-mentioned aspects of the present invention, during a wireless communication using the second communication unit with the second communicating system which covers a wide area, when the area detection unit detects that the mobile communication terminal has just entered a wireless service area, the control unit automatically switches from the second communication mode using the second communication unit to the first communication mode using the first communication unit. Thus, the user does not need to change manually to the first communication mode using the first communication system which covers a local area, e.g., a wireless LAN.

According to the above-mentioned aspects of the present invention, when the area detection unit detects that the mobile communication terminal has just entered a wireless service area, the control unit sends positional data of the mobile communication terminal having this control unit which has been determined by the position determining unit via the first communication system which is covered locally using a first communication unit or via the second communication system covering a wide area using the second communication unit, respectively. Thus, it is ensured that the latest information on wireless service areas is provided to the server.

According to the above-mentioned aspects of the present invention, when the area detection unit detects that the terminal has just left the wireless service area, the control unit sends to a server positional data of the mobile communication terminal which has been determined by the position determining unit via the second wide-area communication system using the second communication unit. Thus, it is ensured that the latest information on wireless service areas is provided to the server.

According to the above-mentioned aspects of the present invention, when the area detection unit of the mobile communication terminal detects that the mobile communication terminal has just entered or left a wireless service area, the notification unit notifies of this event; thus the user can know that he or she has just entered or left a wireless service area of the first communication system which is covered locally. At the same time, a control unit sends to the server positional data of the mobile communication terminal which has been determined by the position determining unit, and the server manages the received positional data as information on the wireless service areas of the first communication system which is covered locally. Thus, it is ensured that the server is always kept updated with latest information on wireless service areas, and can provide mobile communication terminal with the data on wireless service areas using the transmission unit if necessary.

Procedures for switching from a second communication mode using the CDMA2000 1xEV-DO network to a first communication mode using a wireless LAN is cumbersome for uses in conventional systems, whereas the mobile communication terminal according to the present invention automatically switches communication modes when a user has just entered or left a hotspot, thereby increasing the usage and enhance convenience of wireless LAN.

Furthermore, since it is ensured that the latest hotspot information is uploaded to the server in real time and is provided to the user, the user does not need to search hotspots. The user can have up-to-the-minute information on available hotspots.

### BRIEF DESCRIPTION OF THE DRAWINGS

FIG. 1 is a block diagram illustrating a wireless communication system according to one embodiment of the present invention; and

FIG. 2 is a block diagram illustrating a mobile telephone according to one embodiment of the present invention.

### DETAILED DESCRIPTION OF THE INVENTION

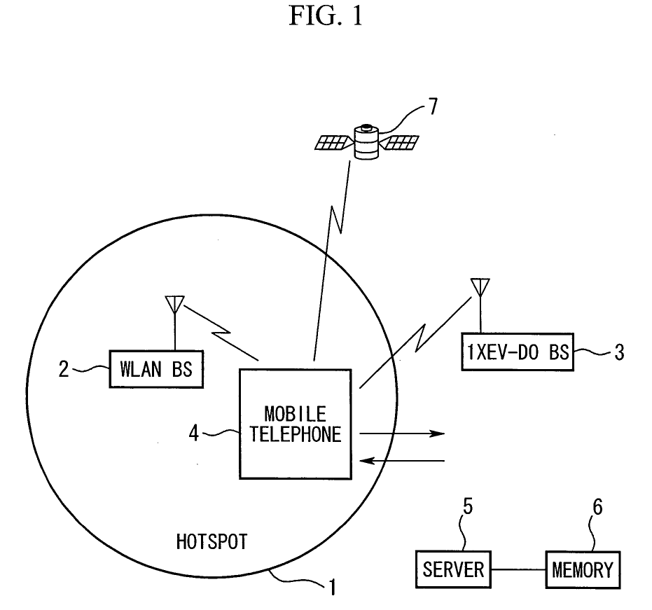

FIG. 1 illustrates a wireless communication system according to one embodiment of the present invention.

In a wireless communication system of this embodiment, a mobile telephone is used as dual-mode mobile communication terminal which has two modes of communication: a wireless LAN mode (a first communication mode) for communicating via a first communication system which covers a local area, and another communication mode for communicating via a different communication system, e.g., the CDMA2000 1xEV-DO network (a second communication mode using a second communication system which covers a wide area), and automatically switches between the two modes. For simplicity, the first communication system will be simply refereed to as the “wireless LAN”, and the second communication system will be refereed to as the “CDMA2000 1xEV-DO network” in the following descriptions. Similarly, the first communication mode using the wireless LAN will be simply referred to as the “wireless LAN mode”, and the second communication mode using the CDMA2000 1xEV-DO network and the like will be refereed to as the “CDMA2000 1xEV-DO mode”.

For achieving this operation, the mobile telephone detects that it has just entered a hotspot of the wireless LAN, and automatically switches from the CDMA2000 1xEV-DO mode to the wireless LAN mode in response to this detection. At the same time, the mobile telephone obtains its position from a GPS (global positioning system), and uploads the obtained the positional data via a wireless LAN or the CDMA2000 1xEV-DO network to a server which keeps track of the hotspot information in the past, thereby updating the hotspot information. When the mobile telephone detects that it has just left the hotspot of the wireless LAN, the mobile telephone automatically switches from the wireless LAN mode to the CDMA2000 1xEV-DO mode. In addition, the mobile telephone obtains its position from the GPS, and uploads the obtained positional data to the server via the CDMA2000 1xEV-DO network, thereby updating the hotspot information.

First, the configurations of the communication system and the mobile telephone according to the present invention will be described. In FIG. 1, reference numeral 1 refers to a hotspot of the wireless LAN, reference numeral 2 refers to a WLAN base station which provides a wireless LAN connection within the hotspot 1, reference numeral 3 refers to a CDMA2000 1xEV-DO base station which provides a CDMA2000 1xEV-DO connection, and reference numeral 4 refers to a mobile telephone which communicates with the wireless LAN within the hotspot 1 and the CDMA2000 1xEV-DO network. Reference numeral 5 refers to a server which communicates with the WLAN base station 2 and the 1x-EV DO base station 3 via communication links, e.g., the Internet. The server 5 includes a memory 6 for storing positional data on hotspots. Reference numeral 7 refers to a global positioning system (GPS) for detecting the position of the mobile telephone 4.

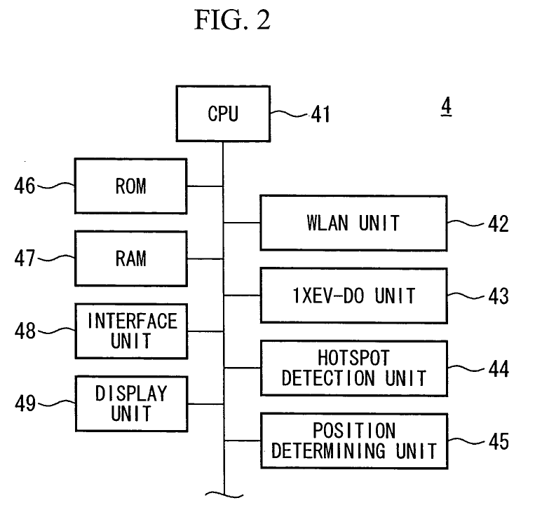

FIG. 2 is a block diagram illustrating an exemplary configuration of the mobile telephone 4.

The mobile telephone 4 includes a CPU 41, a wireless LAN communication unit 42, a CDMA2000 1xEV-DO communication unit 43, a hotspot detection unit 44, a position determining unit 45, a ROM 46, a RAM 47, an interface unit 48, and a display unit 49.

Next, the operation of the system mentioned above will be described.

In FIG. 1, the mobile telephone 4 communicates with both the WLAN base station 2 and the 1x-EV DO base- station 3 using the predetermined signaling. The memory 6 of the server 5 stores hotspot information which includes the positions of the hotspots in the past.

In FIGS. 1 and 2, when the hotspot detection unit 44 of the mobile telephone 4 detects that the mobile telephone 4 has just entered a wireless service area, i.e., the hotspot 1 of the wireless LAN, based on signals from the WLAN base station 2, the CPU 41 automatically switches communication modes from the CDMA2000 1xEV-DO mode to the wireless LAN mode, and configures the necessary settings.

At the same time, in response to the detection, the position determining unit 45 obtains the current position of the mobile telephone 4 from the GPS 7, and uploads the obtained positional data to the server 5 via the CDMA2000 1xEV-DO base station 3 using the CDMA2000 1xEV-DO communication unit 43. Alternatively, the positional data is uploaded to the server 5 via the WLAN base station 2 using the wireless LAN communication unit 42. In this manner, the past hotspot information stored in the memory 6 of the server 5 is updated.

Thus, a user of the mobile telephone 4 can exchange e-mails or browse web sites on the Internet via a wireless LAN link, a high-speed data network, using the mobile telephone 4.

If the user of the mobile telephone 4 leaves the hotspot 2 of the wireless LAN, or if the hotspot detection unit 44 detects that the data rate over the wireless LAN link falls below a predetermined value, the CPU 41 automatically switches from the wireless LAN mode to the CDMA2000 1xEV-DO, and configures the necessary settings. At the same time, the position determining unit 45 obtains the current position of the mobile phone 4 from the GPS 7, and uploads the obtained positional data to the server 5 via the CDMA2000 1x-EV DO base station 3 using the CDMA2000 1xEV-DO communication unit 43, thereby updating the hotspot information stored in the memory 6.

According to this embodiment of the present invention, the mobile telephone automatically switches communication modes between the wireless LAN mode and the CDMA2000 1xEV-DO mode, thereby eliminating users' intervention. This may enhance the usability for users, for example, the time required for switching between modes can be reduced even when a user is downloading a file. Also, a user can enjoy a multimedia content which is provided as a streaming media without feeling any stress from cumbersome procedures for switching modes because a wireless telephone does this automatically.

Furthermore, it is ensured that the current positions of the hotspots of wireless LAN which are constantly changing are updated in the memory 6 in real time.

As described above, since the latest hotspot information are updated in the memory 6 in real time, by requesting the positional data and displaying on the display unit 49, a user can obtain information on available hotspots and the boundaries of the hotspots. Furthermore, even when one of the hotspots becomes unavailable, a user can obtain the latest hotspot information in real time since the information is automatically updated, thus making access to the wireless LAN easier. In addition, the user does not need to search for hotspot information in sources which are updated less frequently, such as books, television, and the Internet.

Furthermore, since the mobile telephone 4 receives the latest hotspot information stored in the memory 6 via the wireless LAN or the CDMA2000 1xEV-DO network while the mobile telephone 4 is within the hotspot, the user of the mobile telephone 4 can make the decision to stay within the hotspot until the streaming of a multimedia content or downloading of a file is completed, rather than walking out of it.

Although one embodiment of the present invention has been described using a mobile telephone as an example of a mobile communication terminal, other types of mobile terminal, such as personal computers may be used. Furthermore, other data communication technology different from the CDMA2000 1xEV-DO scheme may be employed.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. A mobile communication terminal comprising:
a first communication unit for communicating over a wireless communication with a first communication system which covers a local area;
a second communication unit for communicating over a wireless communication with a second communication system which covers a wide area;
an area detection unit for detecting a wireless service area of the first communication system; and
a control unit for switching from a second wireless communication path established by the second communication unit to a first wireless communication path established by the first communication unit in response to the area detection unit detecting a wireless service area while communicating over the wireless communication using the second communication unit.

2. The mobile communication terminal according to claim 1, wherein the control unit switches from the first communication path established by the first communication unit to the second communication path established by the second communication unit in response to the area detection unit losing a signal from the wireless service area.

3. The mobile communication terminal according to claim 1, wherein the second communication system is a system employing the CDMA2000 1xEV-DO technology.

4. A mobile communication terminal comprising:
a first communication unit for communicating over a wireless communication with a first communication system which covers a local area;
a second communication unit for communicating over a wireless communication with a second communication system which covers a wide area;
an area detection unit for detecting a wireless service area of the first communication system;
a position determining unit for determining a position of the mobile communication terminal; and
a control unit for sending positional data of the mobile communication terminal determined by the position determining unit to a server via one of the first and the second communication units in response to the area detection unit detecting the wireless service area.

5. The mobile communication terminal according to claim 4 further comprising:
a service area information receiving unit for receiving information on at least one of wireless service areas of the first communication system from a server via one of the first and the second communication units; and
a notification unit for indicating the at least one of the wireless service areas of the first communication system based on the received information on the at least one of the wireless service areas.

6. The mobile communication terminal according to claim 4, wherein the control unit sends the positional data to a server while communicating over the wireless communication using the second communication unit.

7. The mobile communication terminal according to claim 4, wherein the second communication system is a system employing the CDMA2000 1xEV-DO technology.

8. A mobile communication terminal comprising:
a first communication unit for communicating over a wireless communication with a first communication system which covers a local area;
a second communication unit for communicating over a wireless communication with a second communication system which covers a wide area;
an area detection unit for detecting a wireless service area of the first communication system;
a position determining unit for determining a position of the mobile communication terminal; and
a control unit for sending positional data of the mobile communication terminal determined by the position determining unit to a server via the second communication unit in response to the area detection unit losing a signal from the wireless service area.

9. The mobile communication terminal according to claim 8 further comprising:
a service area information receiving unit for receiving information on at least one of wireless service areas of the first communication system from a server via one of the first and the second communication units; and
a notification unit for indicating the at least one of the wireless service areas of the first communication system based on the received information on the at least one of the wireless service areas.

10. The mobile communication terminal according to claim 8, wherein the control unit sends the positional data to a server while communicating over the wireless communication using the second communication unit.

11. The mobile communication terminal according to claim 8, wherein the second communication system is a system employing the CDMA2000 1xEV-DO technology.

12. A wireless communication system comprising:
a mobile communication terminal for communicating over a first communication system which covers a local area and over a second communication system which covers a wide area, and
a server for managing data received from the mobile communication terminal,
wherein the mobile communication terminal comprises:
an area detection unit for detecting a wireless service area of the first communication system;
a position determining unit for determining a position of the mobile communication terminal;
a control unit for sending positional data of the mobile communication terminal determined by the position determining unit to the server in response to one of the following events: the area detection unit detecting the wireless service area, and the area detection unit losing a signal from the wireless service area;
a service area information receiving unit for receiving information on at least one of wireless service areas of the first communication system from the server; and
a notification unit for indicating the at least one of the wireless service areas of the first communication system based on the received information on the at least one of the wireless service areas, and
the server comprises:
a receiving unit for receiving from the mobile communication terminal positional data related to a wireless service area of the first communication system;
a managing unit for managing the received positional data as the information on the at least one of the wireless service areas; and
a transmission unit for sending the information on the at least one of the wireless service areas managed by the managing unit to the mobile communication terminal.
